(19) United States
(12) Patent Application Publication
(10) Pub. No.: US 2026/0163465 A1
(43) Pub. Date: Jun. 11, 2026

(54) SINGLE-STAGE VOLTAGE-ADJUSTABLE RECTIFICATION SYSTEM WITH MULTI-OUTPUT FULL-WAVE RECTIFICATION

(71) Applicant: Nanjing University, Nanjing (CN)

(72) Inventors: Hao Qiu, Nanjing (CN); Quanrong Zhuang, Nanjing (CN); Junyi Sun, Nanjing (CN); Bo Li, Nanjing (CN); Jie Lu, Nanjing (CN); Yi Shi, Nanjing (CN)

(21) Appl. No.: 19/379,905

(22) Filed: Nov. 5, 2025

(30) Foreign Application Priority Data
Dec. 11, 2024 (CN) 202411826698.2

(51) Int. Cl. H02M 1/00; H02J 50/12; H02M 1/14; H02M 7/219

(52) U.S. Cl. CPC H02M 1/009; H02J 50/12; H02M 1/0025; H02M 1/14; H02M 7/219; H02J 2105/46

(57) ABSTRACT

This application provides a single-stage voltage-adjustable rectification system with multi-output full-wave rectification, including a rectifier and a control module. The rectifier includes a producing module, an idling switch component, a first transistor component, a second transistor component, a load, and a third transistor component in electrical connection. The producing module is configured for producing alternating input voltage. The first transistor component and the second transistor component are configured for generating, based on the alternating input voltage, DC output voltage. The load is configured for obtaining the DC output voltage. The control module is configured for: if the DC output voltage is not within a target voltage range, controlling, based on the DC output voltage and a DC output voltage reference level, the idling switch component, the first transistor component, the second transistor component, and the third transistor component to turn on or off, such that the DC output voltage is within the target voltage range, to enable to simultaneously adjust output voltage values at multiple output ports in a rectifier circuit with multiple outputs.

### CROSS-REFERENCE TO RELATED APPLICATION

The present application claims the benefit of Chinese Patent Application No. 202411826698.2, filed on Dec. 11, 2024, which is incorporated herein by reference in its entirety.

### TECHNICAL FIELD

This disclosure relates to the field of rectifier circuit technology, and in particular, to a single-stage voltage-adjustable rectification system with multi-output full-wave rectification.

### BACKGROUND

Wireless energy transmission technology has been widely applied to current implantable biomedical devices, including cochlea, retinas, and neural prostheses, etc. In a wireless power transmission system, generally, it is preferred to select a power receiver of tens of milliwatts, so as to power multiple voltage stabilizing power rails supporting various functions. To implement efficient power transfer in an implantable device, generally, the goal as described above is achieved using a wireless power transmission system.

For a conventional wireless power transmission system, a rectifier circuit with single input and multiple outputs is used, to supply power at different electricity output ports through time division multiplexing. A load connected to an electricity output port is charged when supply voltage at the electricity output port reaches voltage needed by the load, thereby not only implementing efficient electricity supply, but also enabling it to supply power at multiple electricity output ports.

However, in application, when supply voltage to some of loads of the multiple electricity output ports does not reach the required voltage, and supply voltage to some of the loads reaches the required voltage, positive channel metal oxide semiconductor (PMOS) transistors corresponding to some output direct current (DC) voltage in the rectifier circuit are disabled from conduction. If subsequently the rectifier circuit remains in a mode of charging, it may occur that input voltage of the rectifier circuit exceeds output voltage, as well as gate voltage of the PMOS transistors, such that body diodes of the PMOS transistors are enabled to conduct, thereby causing the rectifier circuit to fail its voltage stabilizing function or even be damaged. If it switches to an idling mode, the rectifier circuit cannot implement normal power supply at an electricity output port corresponding to a load to which the supply voltage does not reach the required voltage, thereby limiting the rectifier circuit's output power and a degree of freedom to adjust voltage.

### SUMMARY

This application provides a single-stage voltage-adjustable rectification system with multi-output full-wave rectification, capable of solving a technical problem that power output by electricity output ports in an existing rectifier circuit with multiple outputs cannot be adjusted.

This disclosure provides a single-stage voltage-adjustable rectification system with multi-output full-wave rectification, including
a rectifier and a control module, where the rectifier is in communication connection with the control module, and
where the rectifier includes a producing module, an idling switch component, a first transistor component, a second transistor component, a load, and a third transistor component in electrical connection, wherein the producing module is connected in parallel with the idling switch component, the idling switch component and the load are connected in parallel with the first transistor component, the second transistor component, and the third transistor component, and the first transistor component, the second transistor component, and the third transistor component are connected in parallel with each other,
wherein the producing module is configured for producing alternating current (AC) input voltage,
wherein the first transistor component, the second transistor component, and the third transistor component are configured for
generating, based on the AC input voltage, direct current (DC) output voltage,
wherein the load is configured for
obtaining the DC output voltage,
wherein the control module is configured for:
determining a DC output voltage reference level;
obtaining a target voltage range based on the DC output voltage reference level; and
controlling, based on the DC output voltage and the DC output voltage reference level, the idling switch component, the first transistor component, the second transistor component, and the third transistor component to turn on/off if the DC output voltage is not within the target voltage range, to make the DC output voltage within the target voltage range,
wherein the third transistor component (7) is provided with at least one positive channel metal oxide semiconductor (PMOS) transistor or negative channel metal oxide semiconductor (NMOS) transistor, wherein a plurality of the at least one PMOS transistor or NMOS transistor is determined by a plurality of the load (6).

In some embodiments, the producing module includes:
a tap coil, a first resonant capacitor, and a second resonant capacitor in electrical connection, wherein a first end of the tap coil (21) is electrically connected to a first end of the first resonant capacitor, and a second end of the tap coil is connected electrically to a first end of the second resonant capacitor, and a tap of the said tapped coil is electrically connected to the second end of the first resonant capacitor and the second end of the second resonant capacitor, and
wherein the idling switch component includes
a first idling switch and a second idling switch in electrical connection, wherein the first idling switch is connected in series with the second idling switch, the first idling switch is connected in parallel with the first resonant capacitor, and the second idling switch is connected in parallel with the second resonant capacitor.

In some embodiments, the first transistor component includes
a first PMOS transistor and a second PMOS transistor in electrical connection,
wherein the first PMOS transistor and the second PMOS transistor are connected in a cross-coupled structure.

In some embodiments, the second transistor component includes
a first NMOS transistor, a second NMOS transistor, a first comparator, and a second comparator in electrical connection, wherein the first NMOS transistor and the second NMOS transistor are connected in parallel with each other, the first NMOS transistor is connected in series with the first comparator, and the second NMOS transistor is connected in series with the second comparator,
wherein the first NMOS transistor and the second NMOS transistor are of a structure of an active diode.

In some embodiments, the load includes
a load voltage stabilizing capacitor, a load resistor, and a load component in electrical connection, wherein the load voltage stabilizing capacitor, the load resistor, and the load component are connected in parallel with each other, and the load component is provided with a plurality of load voltage stabilizing capacitors and load resistors,
wherein the first load voltage stabilizing capacitor is configured for
obtaining first DC output voltage, and
wherein the load component is configured for
obtaining second DC output voltage.

In some embodiments, the control module is further configured for:
obtaining a load current based on the second DC output voltage;
obtaining, based on the load current, a load state of the load current, wherein the load state includes a light load state and a heavy load state;
controlling the idling switch component, the first transistor component, the second transistor component, and the third transistor component on/off if the load current is in the light load state, to make the first DC output voltage within a first target voltage range, and the second DC output voltage within a second target voltage range; and
controlling the first PMOS transistor and the third transistor component on if the load current is in the heavy load state, to make the first DC output voltage within the first target voltage range, and the second DC output voltage within the second target voltage range.

In some embodiments, the control module is further configured for:
when the load current is in the light load state, if the first DC output voltage is less than a first DC output voltage reference level and the second DC output voltage is less than a second DC output voltage reference level, controlling the first PMOS transistor, the second NMOS transistor, and the third transistor component on, to make the first DC output voltage within the first target voltage range, and the second DC output voltage within the second target voltage range;
if the first DC output voltage is less than the first DC output voltage reference level and the second DC output voltage is greater than the second DC output voltage reference level, controlling the first PMOS transistor and the second NMOS transistor on, to make the first DC output voltage within the first target voltage range, and the second DC output voltage within the second target voltage range; and
if the first DC output voltage is greater than the first DC output voltage reference level and the second DC output voltage is greater than the second DC output voltage reference level, controlling the idling switch component on, to make the first DC output voltage within the first target voltage range, and the second DC output voltage within the second target voltage range.

In some embodiments, the control module includes:
a first hysteresis comparator, a second hysteresis comparator, a third hysteresis comparator, a D flip flop component, a logic gate component, a phase inverter chain delay circuit, and a phase inverter component in electrical connection, wherein
the first hysteresis comparator is configured for obtaining a first result of comparison based on the first DC output voltage and the first DC output voltage reference level,
the second hysteresis comparator is configured for obtaining a second result of comparison based on the second DC output voltage and the second DC output voltage reference level,
the third hysteresis comparator is configured for
obtaining a reference voltage based on the second DC output voltage reference level, and
obtaining a third result of comparison based on the second DC output voltage and the reference voltage, and
the logic gate component is configured for generating a trigger signal based on the first result of comparison, the second result of comparison, and the third result of comparison, wherein the trigger signal is configured for controlling the idling switch component, the first transistor component, the second transistor component, and the third transistor component on/off, to make the first DC output voltage within the first target voltage range, and the second DC output voltage within the second target voltage range.

In some embodiments, the control module is further configured for:
controlling the first PMOS transistor and the third transistor component on if the load current is in the heavy load state, to make the first DC output voltage within the first target voltage range, and the second DC output voltage within a third target voltage range obtained by the reference voltage and the second DC output voltage reference level.

In some embodiments, the first comparator and the second comparator include:
a PMOS transistor component and an NMOS transistor component in electrical connection,
wherein the first comparator or the second comparator outputs a low level when a numerical value of a signal to be compared which is input to the first comparator or the second comparator is greater than a numerical value at a positive terminal of supply voltage of the first comparator or the second comparator, and the first comparator or the second comparator outputs a high level when the numerical value of the signal to be compared which is input to the first comparator or the second comparator is less than or equal to the numerical value at the positive terminal of the supply voltage of the first comparator or the second comparator.

This application provides a single-stage voltage-adjustable rectification system with multi-output full-wave rectification, including a rectifier and a control module, wherein the rectifier is in communication connection with the control module, and wherein the rectifier includes a producing module, an idling switch component, a first transistor component, a second transistor component, a load, and a third transistor component in electrical connection, wherein the producing module is connected in parallel with the idling switch component, the idling switch component and the load are connected in parallel with the first transistor component and the second transistor component, and the first transistor component is connected in parallel with the second transistor component, wherein the producing module is configured for producing alternating current (AC) input voltage, wherein the first transistor component and the second transistor component are configured for generating, based on the AC input voltage, DC output voltage, wherein the load is configured for obtaining the DC output voltage, wherein the control module is configured for: obtaining a DC output voltage reference level; obtaining a target voltage range based on the DC output voltage reference level; and controlling, based on the DC output voltage and the DC output voltage reference level, the idling switch component, the first transistor component, the second transistor component, and the third transistor component on/off if the DC output voltage is not within the target voltage range, to make the DC output voltage within the target voltage range, thereby enabling to simultaneously adjust output voltage values at multiple output ports in a rectifier circuit with multiple outputs.

### BRIEF DESCRIPTION OF DRAWINGS

To describe a technical solution of this application more clearly, a simple introduction to drawings to be used in embodiments is given below. Obviously, for a person of ordinary skill in the art, other drawings may further be obtained based on these drawings without creative efforts.

FIG. 1 is a first diagram of a structure of a single-stage voltage-adjustable rectification system with multi-output full-wave rectification in this application.

FIG. 2 is a second diagram of a structure of a single-stage voltage-adjustable rectification system with multi-output full-wave rectification in this application.

FIG. 3 is a structure diagram of a control module in this application.

FIG. 4 is a structure diagram of a first comparator and a second comparator in this application.

FIG. 5 is a structure diagram of a present wireless power transmission system.

FIG. 6 is a structure diagram of a present rectifier circuit with single input and multiple outputs.

FIG. 7 is a structure diagram of a rectifier circuit in a mode of two-side charging in this application.

FIG. 8 is a structure diagram of a rectifier circuit in a mode of high-side charging in this application.

FIG. 9 is a structure diagram of a rectifier circuit in an idling mode in this application.

FIG. 10 is a structure diagram of a rectifier circuit in a mode of electric charge distribution in this application.

FIG. 11 is a diagram of transient-state switching performance of a rectifier circuit without the mode of electric charge distribution in this application.

FIG. 12 is a diagram of transient-state switching performance of a rectifier circuit with the mode of electric charge distribution in this application.

FIG. 13 is illustrative waveforms of input and output voltage of a rectifier circuit in a mode of two-side charging in this application.

FIG. 14 is test waveforms of input and output voltage, as well as NMOS gate voltage, of a rectifier circuit with a first load in this application.

FIG. 15 is test waveforms of input and output voltage, as well as NMOS gate voltage, of a rectifier circuit with a second load in this application.

FIG. 16 is test waveforms of input and output voltage, as well as NMOS gate voltage, of a rectifier circuit with a third load in this application.

FIG. 17 is test waveforms of input and output voltage, as well as NMOS gate voltage, of a rectifier circuit with a fourth load in this application.

FIG. 18 is a first diagram of waveforms of two output voltage of a rectifier circuit as well as a load switching signal in case of a sudden change in a load current in this application.

FIG. 19 is a second diagram of waveforms of two output voltage of a rectifier circuit as well as a load switching signal in case of a sudden change in a load current in this application.

FIG. 20 is a diagram of test efficiency of a rectifier circuit under different load magnitudes in this application.

### DESCRIPTION OF REFERENCE SIGNS

1—control module; 11—first hysteresis comparator; 12—second hysteresis comparator; 13—third hysteresis comparator; 14—D flip flop component; 15—logic gate component; 16—phase inverter chain delay circuit; 17—phase inverter component; 2—producing module; 21—tap coil; 22—first resonant capacitor; 23—second resonant capacitor; 3—idling switch component; 31—first idling switch; 32—second idling switch; 4—first transistor component; 41—first PMOS transistor; 42—second PMOS transistor; 5—second transistor component; 51—first NMOS transistor; 52—second NMOS transistor; 53—first comparator; 54—second comparator; 541—PMOS transistor component; 542—NMOS transistor component; 6—load; 61—load voltage stabilizing capacitor; 62—load resistor; 63—load component; 7—third transistor component.

### DETAILED DESCRIPTION OF THE EMBODIMENTS

To enable those skilled in the art to better understand the technical solution of this application, the technical solution will be clearly and completely described below with reference to the accompanying drawings of the embodiments of this application. Obviously, the described embodiments are only a part of the embodiments of this application, not all of them. Based on the embodiments of this application, all other embodiments obtained by those skilled in the art without creative efforts shall fall within the protection scope of this application.

In some technologies, power output by electricity output ports in a rectifier circuit with multiple outputs cannot be adjusted. To solve this technical problem, this application provides a single-stage voltage-adjustable rectification system with multi-output full-wave rectification. A structure of parts of the single-stage voltage-adjustable rectification system with multi-output full-wave rectification is described below.

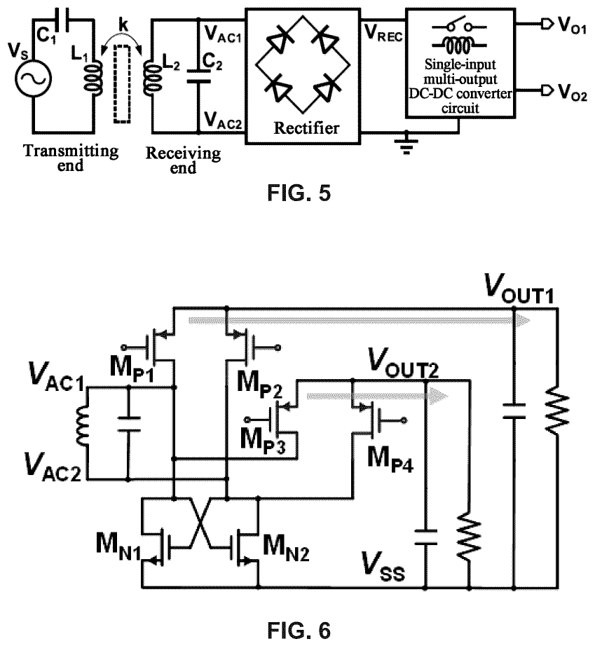

Illustratively, a basic structure of a wireless power transmission system used at present is as shown in FIG. 5, in which an alternating magnetic field is produced through an alternating current on a coil L₁ at a transmitting end, and a coil L₂ at a receiving end produces an alternating current through the alternating magnetic field, which flows through a capacitor C2, thereby producing alternating current (AC) voltage V_{AC1}, V_{AC2}. As any electrical device is to be powered by DC voltage, the AC voltage is further to be changed into DC voltage by a rectifier circuit. The DC voltage V_{REC}obtained by the rectifier may change in magnitude with a change of the input voltage in magnitude, which cannot be used directly. Thus, it is required to be transformed by a subsequent DC-DC circuit with single input and multiple outputs, into multiple stable DC voltage without changing in magnitude with the change of the input voltage in magnitude.

Illustratively, conventional rectifier circuits, for instance, have the following demands.

Demand for stabilizing voltage: in a biomedical wireless energy transmission system, a change in a location of a receiver coil (RX) relative to a transmitter coil (TX) often causes fluctuations in a coupling coefficient. This fluctuation may directly impact a voltage conversion ratio of an entire energy transmission link, and then cause unstable voltage at the RX end. And a RX circuit needs to continuously provide functional modules in a biomedical device with stable DC power supply voltage. Therefore, a rectifier circuit will have to have capabilities to stabilize and adjust voltage.

Demand for multiple outputs: with technical progress in biomedical devices, these devices generally require multiple independent power supply voltages for driving different functional modules, such as an analog amplifier, a digital logic unit, a memory, etc, which further increases the complexity of RX circuit design. Conventional RX circuit design includes one rectifier and multiple DC-DC converters, in charge of converting an alternating current into a direct current, to meet a demand by the devices for a stable power supply and multiple voltage outputs. The DC-DC converters provide an adjustable DC output.

To implement the demand as described above for stabilizing voltage and for multiple outputs, a way of combining a full-bridge rectifier (FBR) and multiple low dropout (LDO) voltage stabilizers is used at present, which requires high power voltage to be output from the TX end to compensate for different link conditions. Meanwhile, a multistage structure and an extra component that are needed inevitably cause cascading power loss, and increase system volume and cost. To solve the limitation of the multistage structure as described above, a single-stage voltage-adjusting rectifier with multiple outputs may be introduced for rectifying and adjusting voltage, to avoid cascading efficiency loss.

Illustratively, a present rectifier circuit with single input and multiple outputs is as shown in FIG. 6, where V_{SS} (a negative terminal of supply voltage of a comparator) is selectively connected to V_{AC1} or V_{AC2} (voltage at either end of an inductor) by negative channel metal oxide semiconductor (NMOS) transistors in a cross-coupled structure, and then, different outputs V_{OUT1} and V_{OUT2} are connected to V_{AC2} or V_{AC1} at different moments through a PMOS transistor configured as an active diode driven by the comparator. When V_{AC1} is at a high level, M_{N2} is enabled to conduct, V_{AC2} is connected to V_{SS}, in which case it may be selected, by logic circuit control, to turn on either of M_{P1} and M_{P3} (which cannot both turn on at the same time). If it is selected to turn on M_{P1}, V_{AC1} is connected to V_{OUT1}, in which case, V_{OUT1} is charged through controlling a current of the inductor by the rectifier circuit; if it is selected to turn on M_{P3}, V_{AC1} is connected to V_{OUT2}, in which case, V_{OUT2} is charged through controlling the current of the inductor by the rectifier circuit; and if both V_{OUT1} and V_{OUT2} are charged to a magnitude of specified voltage at the moment, neither M_{P1} nor M_{P3} turns on, in which case, a switch connected in parallel with the inductor at both ends may close, short-circuiting V_{AC1} and V_{AC2}, in which case, the system enters an idling mode, to implement a voltage-adjusting function of the rectifier circuit.

The following problems exist with the present rectifier circuit with single input and multiple outputs.

1. The NMOSs in the rectifier circuit are connected in a cross-coupled structure, and PMOSs are of the structure of the active diode. A driving loss of NMOS transistors in the cross-coupled structure is very low. As electron mobility of a PMOS is lower than that of an NMOS, the NMOS is far less than the PMOS in size and gate parasitic capacitance with identical on-state resistance.

2. The rectifier circuit supplies power at different electricity output ports by multiplexing. A load connected to an electricity output port is charged when supply voltage at the electricity output port reaches voltage needed by the load, thereby not only implementing efficient electricity supply, but also enabling it to supply power at multiple electricity output ports. However, in application, when supply voltage to some of loads of the multiple electricity output ports does not reach the required voltage, and supply voltage to others of the loads reaches the required voltage, positive channel metal oxide semiconductor (PMOS) transistors corresponding to some output DC voltage in the rectifier circuit are disabled from conduction. If subsequently the rectifier circuit remains in a mode of charging, a phenomenon may occur that input voltage of the rectifier circuit exceeds output voltage, as well as gate voltage of the PMOS transistors, such that body diodes of the PMOS transistors are enabled to conduct, thereby causing the rectifier circuit to fail its voltage stabilizing function or even be damaged. If it switches to an idling mode, the rectifier circuit cannot implement normal power supply at an electricity output port corresponding to a load to which the supply voltage does not reach the required voltage, limiting the rectifier circuit's output power magnitude and a degree of freedom to adjust voltage.

3. The rectifier circuit may perform charging just once in one period, which is half-wave rectification. Under identical conditions, a ripple output of half-wave rectification is twice that of full-wave rectification. Full-wave rectification and half-wave rectification are two basic methods for converting an alternating current (AC) into a direct current (DC). Half-wave rectification is a simple method for rectification, in which alternating current of a positive half period is rectified just by one diode, while alternating current of a negative half period is ignored. This means that the output voltage is produced in just half of each alternating period, such that output DC voltage includes a great pulsating component. Half-wave rectification is of low efficiency, because it fails to make full use of all the period of the alternating current. With full-wave rectification, however, two or four diodes are used to rectify the alternating current of both the positive and negative half periods. In full-wave rectification, whether the AC input is in the positive or negative half period, the output remains a unidirectional DC voltage, which enables more effective utilization of the AC power supply. Full-wave rectification produces output DC voltage with less pulsation than the half-wave rectification, thereby being more stable and efficient than half-wave rectification. Overall, compared to half-wave rectification, full-wave rectification is advantageous in that: it has better rectification efficiency by virtue of utilization of the entire period of the alternating current; and output DC voltage thereof is of less pulsation, leading to better power supply quality, applicable to an occasion of application of great power, thereby enabling to provide a more stable DC power supply.

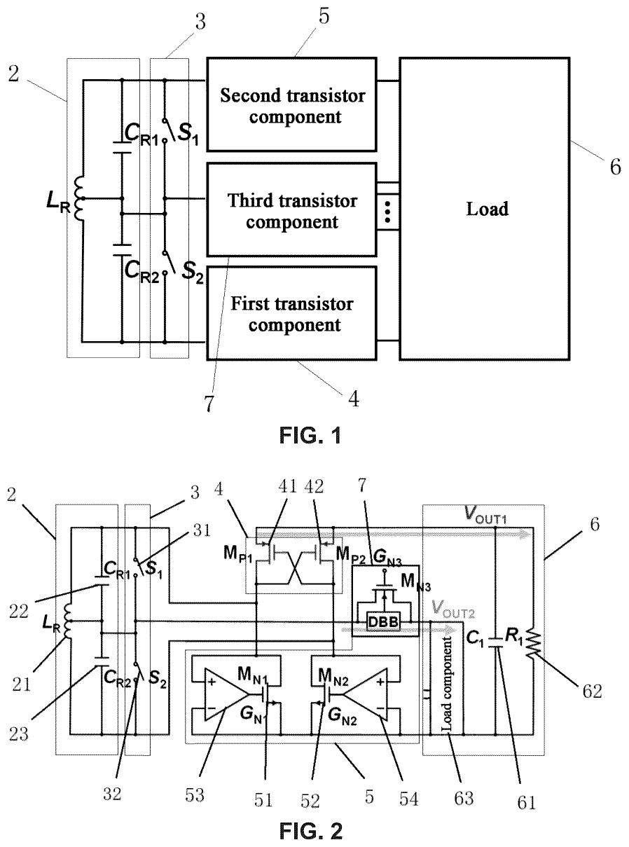

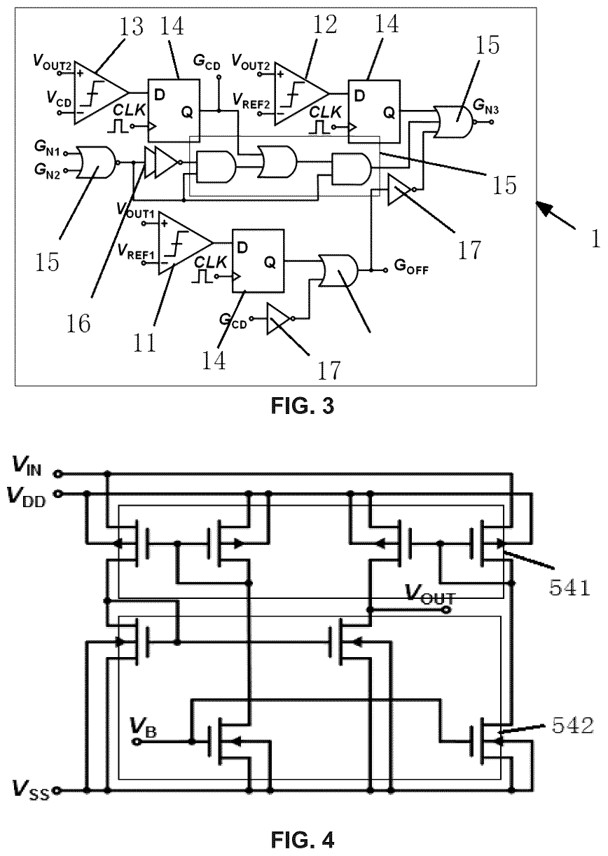

It may be known from FIG. 1 that in view of the problems as described above, this application provides a single-stage voltage-adjustable rectification system with multi-output full-wave rectification, including a rectifier and a control module 1, which are in communication connection with each other. The control module 1 may receive charging voltage Vₒᵤₜ₁ and Vₒᵤₜ₂ of the rectifier in real time. The rectifier is configured for converting AC voltage into DC voltage. The rectifier includes a producing module 2, an idling switch component 3, a first transistor component 4, a second transistor component 5, a load 6, and a third transistor component 7 in electrical connection. The producing module 2 is connected in parallel with the idling switch component 3. The idling switch component 3 and the load 6 are connected in parallel with the first transistor component 4 and the second transistor component 5. The first transistor component 4 and the second transistor component 5 are connected in parallel with the third transistor component 7. The producing module 2 is configured for producing alternating input voltage. For a specific way of producing the alternating input voltage, one may refer to the embodiment of the wireless power transmission system as described above, which is not elaborated here. The first transistor component 4, the second transistor component 5, and the third transistor component 7 are configured for generating, based on the alternating input voltage, DC output voltage. The first transistor component 4 includes a plurality of PMOS transistors. The second transistor component 5 includes a plurality of NMOS transistors. The load 6 is configured for obtaining the DC output voltage. The load 6 includes a plurality of loads, which are charged through the rectifier. The control module 1 is configured for: determining a DC output voltage reference level, which is input by a user from outside, for example if the user wants to charge one load of the loads 6 to 1.5V, she or he just inputs the targeted numerical value 1.5V, i.e., the DC output voltage reference level, to the control module 1, corresponding to V_{REF1} and V_{REF2} in FIG. 3; obtaining a target voltage range based on the DC output voltage reference level. The target voltage range is a range corresponding to respective loads of the loads 6, in which the respective loads are charged to representing completion of the charging. The target voltage range is obtained based on electric charge capturing capability of the respective loads, i.e., voltage in the target voltage range may meet charging voltage requirements of the respective loads; and if the DC output voltage is not within the target voltage range, controlling, based on the DC output voltage and the DC output voltage reference level, the idling switch component 3, the first transistor component 4, the second transistor component 5, and the third transistor component 7 on/off, such that the DC output voltage is within the target voltage range. The third transistor component 7 is provided with at least one PMOS transistor or NMOS transistor. And the number of the at least one PMOS transistor or NMOS transistor is determined by the number of the loads 6.

Illustratively, for each PMOS transistor or NMOS transistor provided to the third transistor component 7, one more load in the loads 6 of the system is provided to connect to the PMOS transistor or the NMOS transistor. It is understood that the single-stage voltage-adjustable rectification system with multi-output full-wave rectification provided in this application may be connected to a plurality of loads.

This application provides a single-stage voltage-adjustable rectification system with multi-output full-wave rectification, which obtains load voltage, i.e., the DC output voltage, in real time through the control module 1, and controlling which of the idling switch component 3, the first transistor component 4, and the second transistor component 5 to be enabled to conduct by determines a magnitude relation between the DC output voltage of the load and required charging voltage of the load, i.e., the DC output voltage reference level, such that the rectifier circuit is enabled to select, based on respective load voltage, to enable which component in the rectifier to conduct, thereby the respective load voltage being within a target voltage range, and implementing power supply at multiple electricity output ports of the rectifier circuit.

Referring to FIG. 2, the producing module 2 includes a tap coil 21, a first resonant capacitor 22, and a second resonant capacitor 23 in electrical connection. A first end of the tap coil 21 is electrically connected to a first end of the first resonant capacitor 22, and a second end of the tap coil 21 is connected electrically to a first end of the second resonant capacitor 23, and a tap of the said tapped coil 21 is electrically connected to the second end of the first resonant capacitor 22 and the second end of the second resonant capacitor 23. The tap coil 21, the first resonant capacitor 22, and the second resonant capacitor 23 correspond to a tap coil L_{R}, a first resonant capacitor C_{R1}, and a second resonant capacitor C_{R2} in FIG. 2, respectively. A current is drawn out through the tap of the coil to charge a low voltage output side, preventing different outputs from taking up each other's charging time, guaranteeing low cross regulation while increasing maximum output power.

The idling switch component 3 includes a first idling switch 31 and a second idling switch 32 in electrical connection. The first idling switch 31 is connected in series with the second idling switch 32. The first idling switch 31 is connected in parallel with the first resonant capacitor 22. The second idling switch 32 is connected in parallel with the second resonant capacitor 23. The first idling switch 31 and the second idling switch 32 correspond to a first idling switch S₁ and a second idling switch S₂ in FIG. 2, respectively.

As shown in FIG. 2, the first transistor component 4 includes a first PMOS transistor 41 and a second PMOS transistor 42 in electrical connection, and the first PMOS transistor 41 and the second PMOS transistor 42 are connected in a cross-coupled structure. The first PMOS transistor 41 and the second PMOS transistor 42 correspond to a first PMOS transistor M_{P1} and a second PMOS transistor M_{P2} in FIG. 2, respectively. A rectifier circuit in which PMOSs use a cross voltage-adjusting structure has lower overall circuit driving loss and better overall efficiency.

As shown in FIG. 2, the second transistor component 5 includes a first NMOS transistor 51, a second NMOS transistor 52, a first comparator 53, and a second comparator 54 in electrical connection. The source of the first NMOS transistor 51 is electrically connected to the source of the second NMOS transistor 52. The drain of the first NMOS transistor 51 is electrically connected to the drain of the first PMOS transistor41 and the gate of the second PMOS transistor 42. The drain of the second NMOS transistor 52bis electrically connected to the drain of the second PMOS transistor 42 and the gate of the first PMOS transistor 41. The gate of the first NMOS transistor 51 is connected to the first comparator 53, and the gate of the second NMOS transistor 52 is connected to the second comparator 54. The first NMOS transistor 51 and the second NMOS transistor 52 correspond to a first NMOS transistor M_{N1} and a second NMOS transistor M_{N2} in FIG. 2, respectively. The first NMOS transistor 51 and the second NMOS transistor 52 are of a structure of an active diode. A rectifier circuit in which NMOSs use the structure of the active diode has lower overall circuit driving loss and better overall efficiency.

As shown in FIG. 2, the load 6 includes a load voltage stabilizing capacitor 61, a load resistor 62, and a load component 63 in electrical connection. The load voltage stabilizing capacitor 61, the load resistor 62, and the load component 63 are connected in parallel with each other. The load component 63 is provided with a plurality of load voltage stabilizing capacitors and load resistors. The load voltage stabilizing capacitor 61 and the load component 63 correspond to a load voltage stabilizing capacitor C₁ and a load resistor R₁ in FIG. 2, respectively. The load voltage stabilizing capacitor 61 is configured for obtaining first DC output voltage. The load component 63 is configured for obtaining second DC output voltage. The load 6 is a load. Note that an example of two loads are described in embodiments of this application, and the rectifier provided in this application may be connected to multiple loads, and to NMOS transistors and PMOS transistors of the number corresponding to that of the loads.

In the embodiment, the control module 1 is further configured for: obtaining a load current based on the second DC output voltage; obtaining, based on the load current, a load state of the load current including a light load state and a heavy load state, which are carrying capacity of the rectifier circuit, where the light load state represents that a load rate of the circuit is less than a load rate at a full-load state of the circuit, and the heavy load state represents that the load rate of the circuit is greater than the load rate at the full-load state of the circuit; if the load current is in the light load state, controlling the idling switch component 3, the first transistor component 4, the second transistor component 5, and the third transistor component 7 on/off, to make the first DC output voltage within a first target voltage range, and the second DC output voltage within a second target voltage range; and if the load current is in the heavy load state, controlling the first PMOS transistor 41 and the third transistor component 7 on, to make the first DC output voltage within the first target voltage range, and the second DC output voltage within the second target voltage range, an operating mode of which corresponds to an operating mode of the rectifier in FIG. 10 as a mode of electric charge distribution.

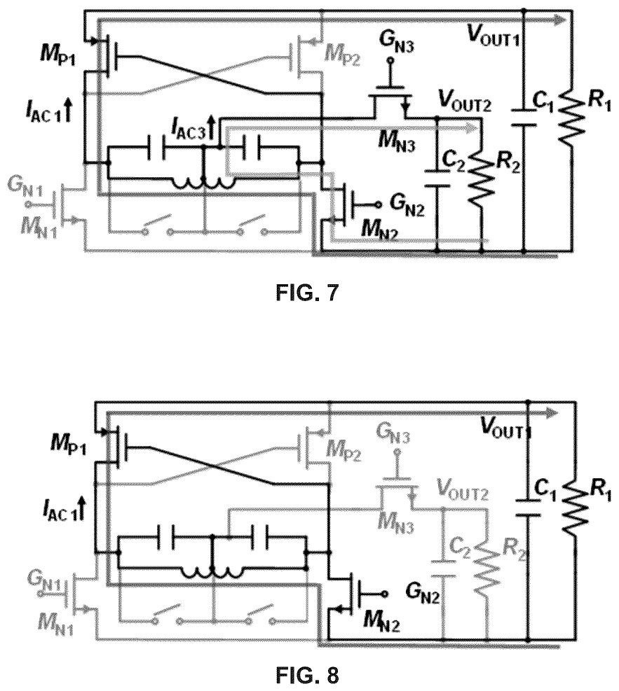

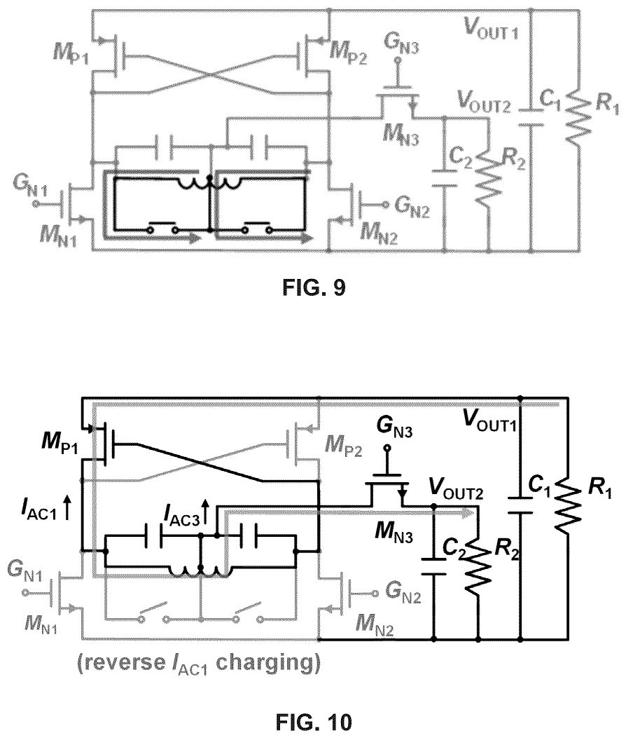

In the embodiment, the control module 1 is further configured for: when the load current is in the light load state, if the first DC output voltage is less than a first DC output voltage reference level and the second DC output voltage is less than a second DC output voltage reference level, controlling the first PMOS transistor 41, the second NMOS transistor 52, and the third transistor component 7 on, to make the first DC output voltage within the first target voltage range, and the second DC output voltage within the second target voltage range, an operating mode of which corresponds to the operating mode of the rectifier in FIG. 7 as a mode of two-side charging; if the first DC output voltage is less than the first DC output voltage reference level and the second DC output voltage is greater than the second DC output voltage reference level, controlling the first PMOS transistor 41 and the second NMOS transistor 52 on, to make the first DC output voltage within the first target voltage range, and the second DC output voltage within the second target voltage range, an operating mode of which corresponds to the operating mode of the rectifier in FIG. 8 as a mode of high-side charging; and if the first DC output voltage is greater than the first DC output voltage reference level and the second DC output voltage is greater than the second DC output voltage reference level, controlling the idling switch component 3 on, to make the first DC output voltage within the first target voltage range, and the second DC output voltage within the second target voltage range, an operating mode of which corresponds to the operating mode of the rectifier in FIG. 9 as an idling mode.

Illustratively, the rectifier may be configured into four operating modes: the mode of two-side charging, the mode of high-side charging, the idling mode, and the mode of electric charge distribution. A selectable mode depends on a condition of the load current at V_{OUT2} (I₂). When I₂ is in a light load, the rectifier operates in the mode of two-side charging, the mode of high-side charging, and the idling mode.

Taking half the period as an example, in the mode of two-side charging, M_{N2}, M_{N3}, and M_{P1} are in an ON state. Simultaneous charging at both V_{OUT1} and V_{OUT2} within half the period may be implemented respectively through currents I_{AC1}/I_{AC2} and I_{AC3}. Therefore, load voltage corresponding to the two loads may both increase. In the mode of high-side charging, M_{N2} and M_{P1} are in the ON state, charging at just V_{OUT1} is implemented through I_{AC1}/I_{AC2}. In the idling mode, S₁ and S₂ are on, V_{OUT1} and V_{OUT2}reduce simultaneously. A controller produces respective logic states by detecting voltage levels of V_{OUT1} and V_{OUT2}, to adjust V_{OUT1} and V_{OUT2} to being within hysteresis windows [V_{REF1L}, V_{REF1H}] and [V_{REF2L}, V_{REF2H}], i.e., within the first target voltage range and the second target voltage range, respectively. During an entire adjusting period, power loss of the rectifier is controlled mainly by the active diode. Compared to a structure of a present rectifier, in this application, NMOSs, rather than PMOSs, are used to implement the structure of the active diode, and the number thereof is reduced to three, thereby reducing the power loss and improving rectifier circuit efficiency, and saving a chip area of a chip of the rectifier.

It is noted that in embodiments of this application, two PMOS transistors, i.e., the first PMOS transistor 41 and the second PMOS transistor 42, are provided. During the operation of the rectifier, each half period corresponds to one PMOS transistor being turned on; that is, the rectifier performs charging twice per period, achieving full-wave rectification, as shown in FIG. 13. Compared to half-wave rectification (where charging is performed once per period), full-wave rectification is advantageous in that it has better rectification efficiency and output DC voltage with less pulsation; thereby improving power supply quality, applying to an occasion of great power, and enabling to provide a more stable DC power supply.

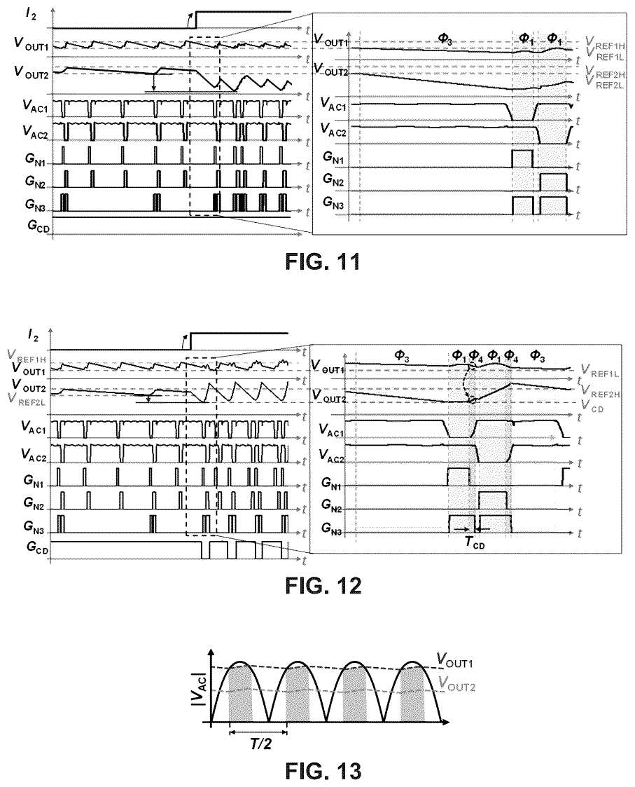

Illustratively, when I₂ switches to being in the heavy load state, the operating mode of the rectifier converts to the mode of electric charge distribution, as shown in FIG. 10, where M_{N3} and M_{P1} are in the ON state. If I₂ switches to the heavy load state, voltage (especially V_{OUT2}) adjustment becomes very challenging. A worst case occurs in the idling mode, in which case, V_{OUT1} and V_{OUT2} both are reducing. As shown in FIG. 11, as I₂ switches from the light load to the heavy load, V_{OUT2} starts to drop along a faster path, first reaching V_{REF2L}, i.e., a minimum value of the second target voltage range. However, the case as described above cannot trigger the mode of two-side charging, otherwise, V_{AC1} and V_{AC2} may increase greatly, thereby performing unnecessary charging at V_{OUT1} through body diodes of M_{P1} and M_{P2}. The idling mode may continue until V_{OUT1} reaches V_{REF1L}, i.e., a minimum value of the first target voltage range. Therefore, great voltage drop of V_{OUT2} is inevitable. On the other hand, a solution is provided through the proposed mode of electric charge distribution together with another reference voltage (V_{CD}) in the control module 1. As shown in FIG. 12, when V_{OUT2} reaches V_{CD}, the idling mode ends, and then the mode of two-side charging is entered. V_{OUT2} stops dropping and starts to increase. In addition, when the mode of two-side charging ends, by turning off M_{N2}, a current path from V_{OUT1} to V_{OUT2} appears, and starts the proposed mode of electric charge distribution. Through the current path, electric charge accumulated at V_{OUT1} in the mode of two-side charging helps relieve the problem of an inadequate charging current at V_{OUT2}. A duration (T_{CD}) of the mode of electric charge distribution is optimized, to maintain high gate-source voltage of M_{P1}, thereby providing a small on-state resistance of M_{P1}. After a few cycles, V_{OUT2} reaches V_{REF2H}, i.e., a maximum value of the second target voltage range, triggering the idling mode. Therefore, through the proposed mode of electric charge distribution, great voltage fall at V_{OUT2} is eliminated, and V_{OUT2} is successfully adjusted to be within the hysteresis window [V_{CD}, V_{REF2H}], i.e., a third target voltage range.

Referring to FIG. 3, the control module 1 includes: a first hysteresis comparator 11, a second hysteresis comparator 12, a third hysteresis comparator 13, a D flip flop component 14, a logic gate component 15, a phase inverter chain delay circuit 16, and a phase inverter component 17 in electrical connection, The logic gate component 15 includes: a NOR gate, an AND gate, and an OR gate. The first hysteresis comparator 11 is configured for obtaining a first result of comparison based on the first DC output voltage V_{OUT1} and the first DC output voltage reference level V_{REF1}. The second hysteresis comparator 12 is configured for obtaining a second result of comparison based on the second DC output voltage V_{OUT2} and the second DC output voltage reference level V_{REF2}. The third hysteresis comparator 13 is configured for obtaining a reference voltage VCD based on the second DC output voltage reference level V_{REF2}, and obtaining a third result of comparison based on the second DC output voltage V_{OUT2} and the reference voltage V_{CD}. The logic gate component 15 is configured for generating a trigger signal based on the first result of comparison, the second result of comparison, and the third result of comparison. The trigger signal is configured for controlling the idling switch component 3, the first transistor component 4, the second transistor component 5, and the third transistor component 7 on/off, to make the first DC output voltage within the first target voltage range, and the second DC output voltage within the second target voltage range. For a specific process of the logic gate component 15 for generating a trigger signal based on the first result of comparison, the second result of comparison, and the third result of comparison, for controlling the idling switch component 3, the first transistor component 4, and the second transistor component 5 on/off as described above, one may refer to the embodiment of the four operating modes configured for the rectifier as described above, which is not elaborated here. G_{CD} represents a trigger signal for the mode of electric charge distribution, which is configured for controlling the rectifier to enter the four operating modes. G_{OFF} represents a gate signal of a switch of the idling mode, which is configured for controlling the idling switch component 3 to close.

In the embodiment, the control module 1 is further configured for: if the load current is in the heavy load state, controlling the first PMOS transistor 41 and the third NMOS transistor 53 on, to make the first DC output voltage within the first target voltage range, and the second DC output voltage within a third target voltage range [V_{CD}, V_{REF2H}] obtained from the reference voltage and the second DC output voltage reference level. For a role and effect of providing the third target voltage range, one may refer to a role and effect of the mode of electric charge distribution as described above, which is not elaborated here.

Referring to FIG. 4, the first comparator 53 and the second comparator 54 include: a PMOS transistor component 541 and an NMOS transistor component 542 in electrical connection. when a numerical value of a signal to be compared which is input to the first comparator 53 or the second comparator 54 is greater than a numerical value at a positive terminal of supply voltage of the first comparator 53 or the second comparator 54, the first comparator 53 or the second comparator 54 outputs a low level, and when the numerical value of the signal to be compared which is input to the first comparator 53 or the second comparator 54 is less than or equal to the numerical value at the positive terminal of the supply voltage of the first comparator 53 or the second comparator 54, the first comparator 53 or the second comparator 54 outputs a high level. V_{IN} denotes the signal to be compared which is input to the comparator, V_{DD}denotes the positive terminal of the supply voltage of the comparator, V_{B} denotes a gate bias voltage of the NMOS transistor, V_{SS} denotes the negative terminal of the supply voltage of the comparator, and V_{OUT} denotes output voltage of the comparator. A principle of how the first comparator 53 as well as the second comparator 54 operates is as follows. First, analog signals are received at two inputs of the comparator; secondly, in a comparison stage, the two input signals are compared to reference voltage (or the other input signal); if a difference between the input signals exceeds a certain threshold (also referred to as a trigger level), an output state of the comparator may change; and finally, the comparator outputs one binary signal, generally denoted by a high level or a low level; the output signal reflects a magnitude relation between an input signal and the reference voltage (or the other input signal).

Illustratively, a 180 nm complementary metal oxide semiconductor (CMOS) process is used for the chip of the rectifier, with a chip area of 1.63 mm². Maximum load currents I₁ and I₂ at V_{OUT1} and V_{OUT2} are 33 mA and 15 mA, respectively, with maximum P_{OUT} of 131 mW. Off-chip resonant capacitance C_{R1} and C_{R2} both are 500 pF. Off-chip output capacitance C_{OUT1} and C_{OUT2} are 150 nF and 200 nF, respectively.

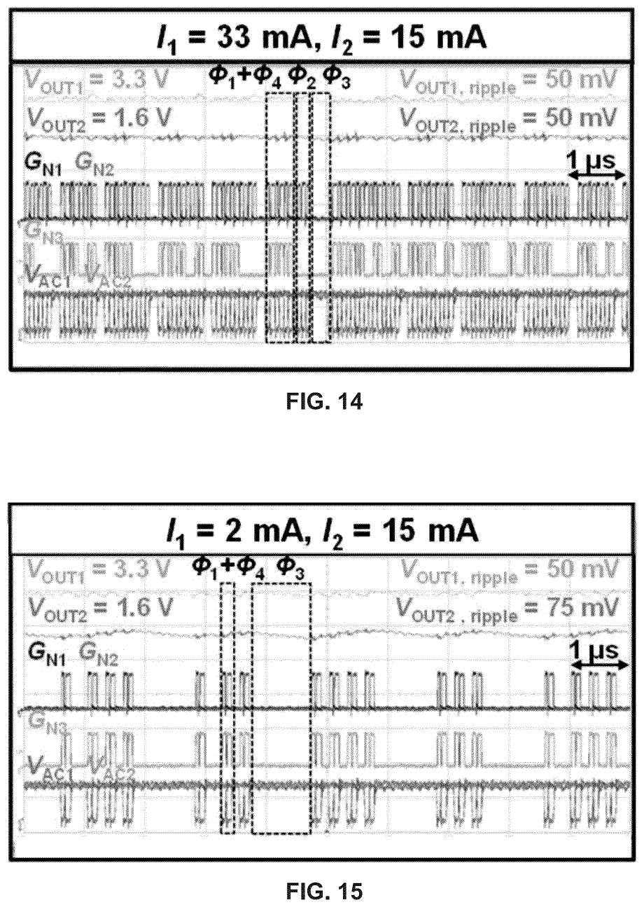

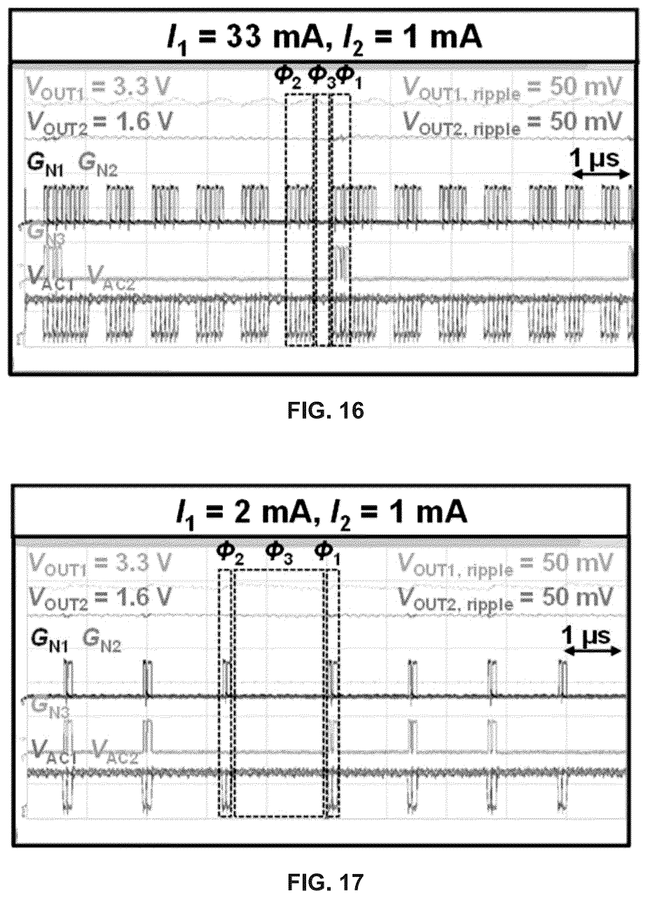

Illustratively, FIG. 14 to FIG. 17 are diagrams of steady-state performance test of the rectifier, showing test waveforms of input and output voltage, as well as NMOS gate voltage, of the rectifier circuit under different loads. Under different combinations of light/heavy loads of I₁ and I₂, V_{OUT1} and V_{OUT2} are respectively adjusted successfully to be 3.3V and 1.6V within the respective hysteresis windows. It may be known from FIG. 14 to FIG. 17 that a maximum ripple of V_{OUT1} and a maximum ripple of V_{OUT2} are as small as 50 mV and 75 mV, respectively. In a steady state, G_{N1}, G_{N2}, and G_{N3} reflect the four operating modes of the rectifier. When G_{N1}, G_{N2}, and G_{N3} each are the high level, it is the mode of two-side charging; when G_{N1} and G_{N2} are the high level, and G_{N3} is the low level, it is the mode of high-side charging; when G_{N1}, G_{N2}, and G_{N3} each are the low level, it is the idling mode; and when G_{N1} and G_{N2} are the low level, and G_{N3} is the high level, it is the mode of electric charge distribution.

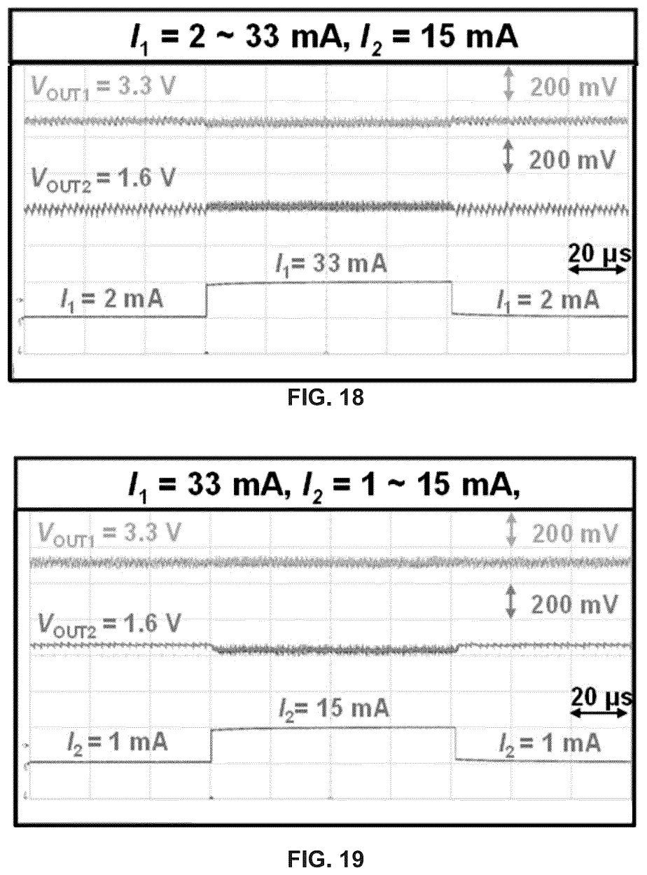

Illustratively, FIG. 18 to FIG. 19 are diagrams of transient-state performance test of the rectifier, showing waveforms of two output voltages of the rectifier circuit as well as a load switching signal in case of a sudden change in a load current; reflecting load transient response and the cross-regulation between the two outputs which is not obvious. When I₂ changes from 1 mA to 15 mA when I₁ is 33 mA, an ignorable voltage drop is implemented in case of load switching by virtue of the proposed mode of electric charge distribution.

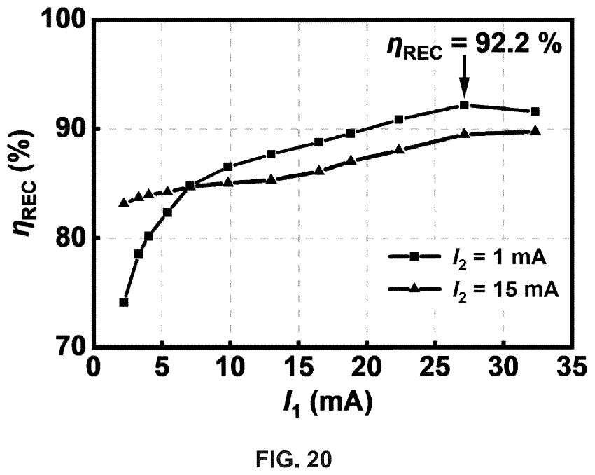

Illustratively, FIG. 20 is actual measurements of efficiency of the rectifier circuit under different load magnitudes. By replacing a PMOS active diode with an NMOS active diode, and reducing the number of high-power transistors to 3, in case that I₂ equals 1 mA, a maximum efficiency of 92.2% energy transformation is obtained by the proposed rectifier when P_{OUT} is 72.6 mW. In case that I₂ equals 15 mA, the rectifier circuit maintains efficiency of 80% and above, with a maximum efficiency of 89.9% energy transformation.

In the above detailed description of the embodiments, the objective, technical solutions, and beneficial effects of the embodiments of this application are further elaborated. It should be understood that the above are just detailed description of the embodiments of this application, rather than for limiting the scope of protection of the embodiments of this application. Any modifications, equivalent replacements, changes, etc., made based on the technical solutions of embodiments of this application shall be included within the scope of protection of the embodiments of this application.

What is claimed is:

1. A single-stage voltage-adjustable rectification system with multi-output full-wave rectification, characterized in that the system comprises:
a rectifier and a control module (1), wherein the rectifier is in communication connection with the control module (1), and
wherein the rectifier comprises a producing module (2), an idling switch component (3), a first transistor component (4), a second transistor component (5), a load (6), and a third transistor component (7) in electrical connection, wherein the producing module (2) is connected in parallel with the idling switch component (3), the idling switch component (3) and the load (6) are connected in parallel with the first transistor component (4), the second transistor component (5), and the third transistor component (7), and the first transistor component (4), the second transistor component (5), and the third transistor component (7) are connected in parallel with each other,
wherein the producing module (2) is configured for producing alternating current (AC) input voltage,
wherein the first transistor component (4), the second transistor component (5), and the third transistor component (7) are configured for generating, based on the AC input voltage, DC (DC) output voltage,
wherein the load (6) is configured for obtaining the DC output voltage,
wherein the control module (1) is configured for:
determining a DC output voltage reference level;
obtaining a target voltage range based on the DC output voltage reference level; and
controlling, based on the DC output voltage and the DC output voltage reference level, the idling switch component (3), the first transistor component (4), the second transistor component (5), and the third transistor component (7) on/off if the DC output voltage is not within the target voltage range, to make the DC output voltage within the target voltage range,
wherein the third transistor component (7) is provided with at least one positive channel metal oxide semiconductor (PMOS) transistor or negative channel metal oxide semiconductor (NMOS) transistor, wherein a plurality of the at least one PMOS transistor or NMOS transistor is determined by a plurality of the load (6).

2. The single-stage voltage-adjustable rectification system with multi-output full-wave rectification according to claim 1, characterized in that the producing module (2) comprises:
a tap coil (21), a first resonant capacitor (22), and a second resonant capacitor (23) in electrical connection, wherein a first end of the tap coil (21) is electrically connected to a first end of the first resonant capacitor (22), and a second end of the tap coil (21) is connected electrically to a first end of the second resonant capacitor (23), and a tap of the said tapped coil (21) is electrically connected to the second end of the first resonant capacitor (22) and the second end of the second resonant capacitor (23), and
wherein the idling switch component (3) comprises
a first idling switch (31) and a second idling switch (32) in electrical connection, wherein the first idling switch (31) is connected in series with the second idling switch (32), the first idling switch (31) is connected in parallel with the first resonant capacitor (22), and the second idling switch (32) is connected in parallel with the second resonant capacitor (23).

3. The single-stage voltage-adjustable rectification system with multi-output full-wave rectification according to claim 1, characterized in that the first transistor component (4) comprises
a first PMOS transistor (41) and a second PMOS transistor (42) in electrical connection,
wherein the first PMOS transistor (41) and the second PMOS transistor (42) are connected in a cross-coupled structure.

4. The single-stage voltage-adjustable rectification system with multi-output full-wave rectification according to claim 3, characterized in that the second transistor component (5) comprises
a first NMOS transistor (51), a second NMOS transistor (52), a first comparator (53), and a second comparator (54) in electrical connection, wherein a source of the first NMOS transistor (51) is electrically connected to a source of the second NMOS transistor (52), a drain of the first NMOS transistor (51) is electrically connected to a drain of the first PMOS (41), a drain of the second NMOS transistor (52) is electrically connected to a drain of the second PMOS transistor (42), a gate of the first NMOS transistor (51) is electrically connected to the first comparator (53), and a gate of the second NMOS transistor (52) is electrically connected to the second comparator (54),
wherein the first NMOS transistor (51) and the second NMOS transistor (52) are of a structure of an active diode.

5. The single-stage voltage-adjustable rectification system with multi-output full-wave rectification according to claim 4, characterized in that the load (6) comprises
a load voltage stabilizing capacitor (61), a load resistor (62), and a load component (63) in electrical connection, wherein the load voltage stabilizing capacitor (61), the load resistor (62), and the load component (63) are connected in parallel with each other, and the load component (63) is provided with a plurality of load voltage stabilizing capacitors and load resistors,
wherein the load voltage stabilizing capacitor (61) is configured for obtaining a first DC output voltage, and
wherein the load component (63) is configured for obtaining a second DC output voltage.

6. The single-stage voltage-adjustable rectification system with multi-output full-wave rectification according to claim 5, characterized in that the control module (1) is further configured for:
obtaining a load current based on the second DC output voltage;
obtaining, based on the load current, a load state of the load current, wherein the load state comprises a light load state and a heavy load state;
controlling the idling switch component (3), the first transistor component (4), the second transistor component (5), and the third transistor component (7) on/off if the load current is in the light load state, to make the first DC output voltage within a first target voltage range, and the second DC output voltage within a second target voltage range; and
controlling the first PMOS transistor (41) and the third transistor component (7) on if the load current is in the heavy load state, to make the first DC output voltage within the first target voltage range, and the second DC output voltage within the second target voltage range.

7. The single-stage voltage-adjustable rectification system with multi-output full-wave rectification according to claim 6, characterized in that the control module (1) is further configured for:
when the load current is in the light load state, if the first DC output voltage is less than a first DC output voltage reference level and the second CDC output voltage is less than a second DC output voltage reference level, controlling the first PMOS transistor (41), the second NMOS transistor (52), and the third transistor component (7) on, to make the first DC output voltage within the first target voltage range, and the second DC output voltage within the second target voltage range;
if the first DC output voltage is less than the first DC output voltage reference level and the second DC output voltage is greater than the second DC output voltage reference level, controlling the first PMOS transistor (41) and the second NMOS transistor (52) on, to make the first DC output voltage within the first target voltage range, and the second DC output voltage within the second target voltage range; and
if the first DC output voltage is greater than the first DC output voltage reference level and the second DC output voltage is greater than the second DC output voltage reference level, controlling the idling switch component (3) on, to make the first DC output voltage within the first target voltage range, and the second DC output voltage within the second target voltage range.

8. The single-stage voltage-adjustable rectification system with multi-output full-wave rectification according to claim 7, characterized in that the control module (1) comprises:
a first hysteresis comparator (11), a second hysteresis comparator (12), a third hysteresis comparator (13), a D flip flop component (14), a logic gate component (15), a phase inverter chain delay circuit (16), and a phase inverter component (17) in electrical connection, wherein
the first hysteresis comparator (11) is configured for obtaining a first result of comparison based on the first DC output voltage and the first DC output voltage reference level,
the second hysteresis comparator (12) is configured for obtaining a second result of comparison based on the second DC output voltage and the second DC output voltage reference level,
the third hysteresis comparator (13) is configured for:
obtaining a reference voltage based on the second DC output voltage reference level, and
obtaining a third result of comparison based on the second DC output voltage and the reference voltage, and
the logic gate component (15) is configured for generating a trigger signal based on the first result of comparison, the second result of comparison, and the third result of comparison, wherein the trigger signal is configured for controlling the idling switch component (3), the first transistor component (4), the second transistor component (5), and the third transistor component (7) on/off, to make the first DC output voltage within the first target voltage range, and the second DC output voltage within the second target voltage range.

9. The single-stage voltage-adjustable rectification system with multi-output full-wave rectification according to claim 8, characterized in that the control module (1) is further configured for:
controlling the first PMOS transistor (41) and the third transistor component (7) on if the load current is in the heavy load state, to make the first DC output voltage within the first target voltage range, and the second DC output voltage within a third target voltage range obtained by the reference voltage and the second DC output voltage reference level.

10. The single-stage voltage-adjustable rectification system with multi-output full-wave rectification according to claim 4, characterized in that the first comparator (53) and the second comparator (54) comprise:
a PMOS transistor component (541) and an NMOS transistor component (542) in electrical connection,
wherein the first comparator (53) or the second comparator (54) outputs a low level when a numerical value of a signal to be compared which is input to the first comparator (53) or the second comparator (54) is greater than a numerical value at a positive terminal of supply voltage of the first comparator (53) or the second comparator (54), and the first comparator (53) or the second comparator (54) outputs a high level when the numerical value of the signal to be compared which is input to the first comparator (53) or the second comparator (54) is less than or equal to the numerical value at the positive terminal of the supply voltage of the first comparator (53) or the second comparator (54).
